(19) United States
(12) Patent Application Publication
(10) Pub. No.: US 2014/0373793 A1
(43) Pub. Date: Dec. 25, 2014

(54) RESISTANCE TRAINING DEVICE FOR QUADRUPEDS AND EQUINES

(71) Applicants: Jill McDermott, Bark River, MI (US); Lynda Reese, South Escanaba, MI (US)

(72) Inventors: Jill McDermott, Bark River, MI (US); Lynda Reese, South Escanaba, MI (US)

(21) Appl. No.: 14/314,944

(22) Filed: Jun. 25, 2014

Related U.S. Application Data
(60) Provisional application No. 61/839,357, filed on Jun. 25, 2013.

(51) Int. Cl. A01K 15/02

(52) U.S. Cl. CPC A01K 15/027
USPC 119/856

(57) ABSTRACT

A resistant training and rehabilitation device for quadruped animals, particularly equines, that encourages a constant self awareness of an animal's own movement by direct contact over connecting muscle groups. The device comprising elastic material that serves as a tension wrap around the animal's front, rear and mid body section such that when the front portion moves in the forward direction, it pushes against the material, causing it to pull against the rear and belly section of the animal. The elastic material further pulls against the lower belly portion of the horse causing it to round and lift the arch of its back, and the horse lowers its neck in response to a neutral position for improved alignment and posture.

### CROSS REFERENCE TO RELATED APPLICATIONS

This nonprovisional utility patent application claims priority benefit of and incorporates by reference the full and complete disclosure of Provisional Patent Application No. 61/839,357, originally filed on Jun. 25, 2013.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### BACKGROUND OF THE INVENTION

1. Field of the Invention

A resistance training device for proprioception training and rehabilitation of animals, specifically a quadruped such as a horse.

2. BACKGROUND

Current art in the area of equine muscular rehabilitation and training devices fall into several unique category of products. The purpose and design of each category of devices are aimed towards achieving a specific set of desired effect. The achieved effects are specific to the particular category of product. A few popular categories of devices include the following: 1) wraps and bands for the restriction of movement and rehabilitation of isolated torn muscle groups, 2) body straps for purposes of retaining the animal in place, 3) warming blankets or wraps for purposes of providing calming comfort, and 4) tension wraps or straps to encourage self awareness during movement. These types of devices within the current art are restricted by their own design and material composition to effect training, rehabilitation and proprioception development of a horse or any quadruped animal. The categorization of devices listed above is ultimately defined by their intended purpose and end effect on the animal. No device exists in the current art that directly addresses the various components and needs of proprioception training and therapy for quadrupeds and equines.

The muscular interaction within a horse's body, particularly in motion, is unique in that the animal's muscular coordination with its environment is dependent on its neurological sensitivity. The sensitivity of the animal's nerves to its external environment and how the body communicates that information within itself will determine the agility of the animal's responsive movement. In the field of equine art, problems relating to subconscious and conscious motor coordination and movement is a common frustration because the cause may occur from any combination of environmental, psychological, physical or neurological factors. Neurological communication between front and hind quarter muscle groups of horses and some other quadrupeds can become disrupted such that front and hind coordination is not optimal. The difficulty in identifying the source of the problem delays rehabilitation and training leading to eventual rejection of the horse for its dedicated purpose.

Unlike other areas of animal therapy and training that focus on distinctive psychological or anatomical issues, the study of proprioception recognizes the interactive relationship between distinct senses in the horse's mind and body in relation to its external environment. It is distinguished from exteroception, by which one perceives the outside world, and interoception, by which one perceives the movement of internal organs such as sensing pain and hunger. “Proprioception” is an awareness of movement derived from muscular, tendon, and articular sources.

Proprioception is further distinguished from kinesthesia by the element of equilibrium or balance. The animal's proprioception of its surrounding environment involves the combination of neurological senses that assist the body's various muscle and tendon groups to coordinate in a subconscious level to move in a proper fluid manner. Unlike kinesthesia which focuses on the body's motion or movement, proprioception focuses on the body's awareness of its movement and behaviors.

In the area of equine training and rehabilitation, frequent problems arise regarding neuromuscular awareness to its immediate environment. A deficiency or lack of such awareness with the environment leads to unpredictable and improper conscious and subconscious movements. The problematic location may vary on the body by circumstance and the period of rehabilitation is unpredictable since the source and scope of injury is often difficult to isolate.

The prior art in the area proprioception training and therapy of equines have only partially addressed the neuromuscular sensory coordination of the animal's body. The parameters of the prior art design are crude at best. The particular method by the TTEAM company, the Tellington TTouch body wrap, provides a loose length of elastic bandage tied to the base of the horse's neck connected a second bandage connected around the rear of the horse's body. A quick release knot connecting the two bandages is located above the back of the animal, creating a sense of lift at the base of the horse's neck and the horse's lower hindquarter. This device claims to provide a form of massage, ground exercise and training that help animals relax and focus, connecting their physical actions with appropriate emotional responses. The problem with this device is that it fails to connect other relevant portions of the horse's body to encourage proper full body posture, independence and confidence in coordinated movement. Further, the minimal level of tension or pressure applied with this device prevents the handler and horse from achieving its potential level of proprioception development and overall training. Lastly, the design of the device is not inherently intuitive and is difficult to apply, requiring substantial study of the knotting and tying process. The difficulty and time required to tie and adjust this device around a horse's body could risk the handler's safety.

Another prior art with similar style of construction is U.S. Pat. No. 6,612,265. It is not intended to be tightly fitted around the horse's body since it is not made of flexible elastic material that can give under pressure. Rather, the intended purpose and effect of this device functions more as a training lead, causing restriction of undesired movements in the horse. An elastic version of this device would fail to achieve the intended purpose of this given patent.

A third prior art is U.S. Pat. No. 7,963,256, providing a motion control device for dog training. The coordination of straps around the animal's body results in automatic restriction of movement by the animal's own movement. This device discourages movement altogether at a certain point, functioning similar to a halter. The straps are not elastic in nature nor would an elastic embodiment be preferred for the intended purpose and operation of this device.

A horse has naturally stronger and weaker areas of the body that direct them away from straighter movement. This is compounded by external factors such as weight and balance of a rider. Movement for these types of work animals and quadrupeds become a matter of psycho-physio reaction to a high contact environment. No device or method currently exists in the field of art that effectively provides guidance to the animal's subconscious mind and body by a direct contact device for rehabilitative and training purposes. As such, considerable need remains for an inventive solution that improves upon equine proprioception training (and quadropeds generally) aimed towards achieving independence, strength, confidence, aligned posture, and improved movement.

All patents and applications referred herein are incorporated by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

### SUMMARY OF INVENTION

The invention herein regards an equine proprioception training device comprising a length of elastic material strategically wrapped around the body of a quadruped animal, in this case a horse. The material has a defined tension grade, width and length. The material is intended to be strategically wrapped around the body of a quadruped animal, preferably near or directly over its front torso, rear torso, neck, back and belly region. The material, when stretched, exerts a certain amount of resistance pressure over muscle groups that are directly and indirectly in contact with said material, heightening self awareness to the animal's own muscle movement and posture. The tension of the material against key muscle points on the animal's body activates nerves near and around said key areas, keeping a level of constant alertness while the strap is being worn and as the animal is in various stages of motion. The degree of pressure and the location or amount of contact can be varied according to the pattern of connections which further aids in the targeted posture adjustment in tandem with muscle coordination training and resistance exercise.

The object of this invention is to provide for a device that encourages a constant self awareness of an animal's own movement by direct contact over connecting muscle groups. The material serves as a tension wrap around the animal's front, rear and mid body section such that when the front portion moves in the forward direction, it pushes against the material, causing it to pull against the rear and belly section of the animal. The horse feels the coordinated push and pull against targeted portions of the body in relation to its natural movement, causing it to respond in a more aware, controlled and measured manner. From the heightened and constant awareness of its own posture during movement, the device allows the animal to propel itself from the hindquarters. Movement becomes more conscious and deliberate while posture is continually reinforced or adjusted relative to the animal's own movement and gait. The elastic material further pulls against the lower belly portion of the horse causing it to round and lift the arch of its back, and the horse lowers its neck in response to a neutral position for improved alignment and posture. This device aids a quadruped animal such as a horse to find a comfortable and efficient balance within itself by developing an intuitive coordination between muscle activity, skeletal posture and fluidity of movement. After a period of use, natural posture is restored to the animal. Independence, confidence and improved mind and body health are facilitated by this device. Training by this type of device will not result in a sense of dependency to the device. Improvements in the horse's coordination may be sustained without the device despite substantial use.

A further object of this invention is to provide for an “elastic resistant training” device for horses and quadrupeds in general. The manner in which this material is wrapped around the animal creates a preferred level of isometric and concentric pressure against the horse's body, resulting in low impact muscular contraction exercises. The tension grade of the material or the preferred pressure against the animal's body by the body wrap may be varied to adjust the level of muscle contraction exercise. Varying pressure of the device against the horse's body further encourages incremental development of muscle awareness to the immediate environment. The key effect of this elastic resistance training is a measured improvement of increased blood flow, strength and range of movement.

A further object of this inventive device is to improve equine balance. In order for a horse to carry itself gracefully and efficiently, it must maintain proper posture. The horse must be encouraged to carry more weight on its hindquarters so as to engage its hindquarters. As proper head and back posture is restored by this device, the legs become more squarely positioned, effectively balancing out the distribution of weight. As the horse's muscles alternately flex and relax more deeply from use of this device, the bending of the hind legs and shortening of the base of support create an elastic tension in the muscles and ligaments that connect hindquarters to forequarters. This elastic tension helps to lighten the forehand in a kind of cantilever action, facilitating strong and proper reflexive motion further founded on proper posture and balance.

A further object of this invention is to provide for a device that can be quickly, easily and intuitively attached to the entire body of a horse by a single person. One embodiment of the invention may include a webbed device that is to be worn over the animal for the specific type of training or therapy sought to achieve. The device should be easily and intuitively worn over the animal's body with minimal connecting pieces to shorten the time for attaching device to the animal.

The preferred embodiment of the invention herein is intended for equines and quadrupeds such as dogs, cats, and livestock such as goats and cattle. The concept of this invention as it regards the manner of construction, the parameters of limiting components and the location of contact on a given user can be replicated and tailored to the special anatomy, kinesthesia and proprioception of bipedal animals such as primates and humans. The core aspect of this concept comprising the use of an elastic band connected at all sides during use. The band having a preferred range of tensity for purposes of creating a desired level of pressure against the animal's body. In the preferred embodiment herein, elongation is approximately 110% of the original gauge length, +/−10%. The material composition of said band may be of any type of breathable elastic material or composite such as spandex, cotton, nylon or polyester. The material may, but preferably does not contain latex material for reasons of skin sensitivity. The band, in the connected position during use would be extended or stretched by the user's body as certain portions of the body are extended by movement. Said extensions causing an equal opposite resistance pressure against opposing sides of the animal's body. The band may be a simple single elastic band with only one point of connection. It may additionally comprise multiple interconnecting points for multiple interconnected pieces of elastic bands creating simple to complex webbing. In any case, the location of the interconnecting points and the direction of equal opposite elastic forces on the body will define the targeted proprioception training experience. The pattern of interconnected points further aiding in targeted posture adjustment in tandem with muscle coordination training and resistance exercise.

The training device and method of use provided herein does not exist in the art at this time. Current products within the market lack the embodiment and capability to encourage the type of training and development that is achievable with this invention. Other features, advantages, and object of the present invention will become more apparent and be more readily understood from the following detailed description, which should be read in conjunction with the accompanying drawings.

### BRIEF DESCRIPTION OF DRAWINGS

FIG. 1 A side perspective view of a preferred embodiment of the invention as provided herein.

FIG. 2 A front right perspective view of the preferred embodiment of the invention as provided herein.

FIG. 3 A front left perspective view of the preferred embodiment of the invention as provided herein.

FIG. 4 A rear side plan perspective view of the preferred embodiment of the invention as provided herein.

FIG. 5 A front side plan perspective view of the preferred embodiment of the invention as provided herein.

FIG. 6 A right side plan view of the preferred embodiment of the invention as provided herein.

FIG. 7 A left side plan view of the preferred embodiment of the invention as provided herein.

FIG. 8 A top forward plan view of the preferred embodiment of the invention as provided herein.

FIG. 9 A top rear plan view of the preferred embodiment of the invention as provided herein.

### DETAILED DESCRIPTION

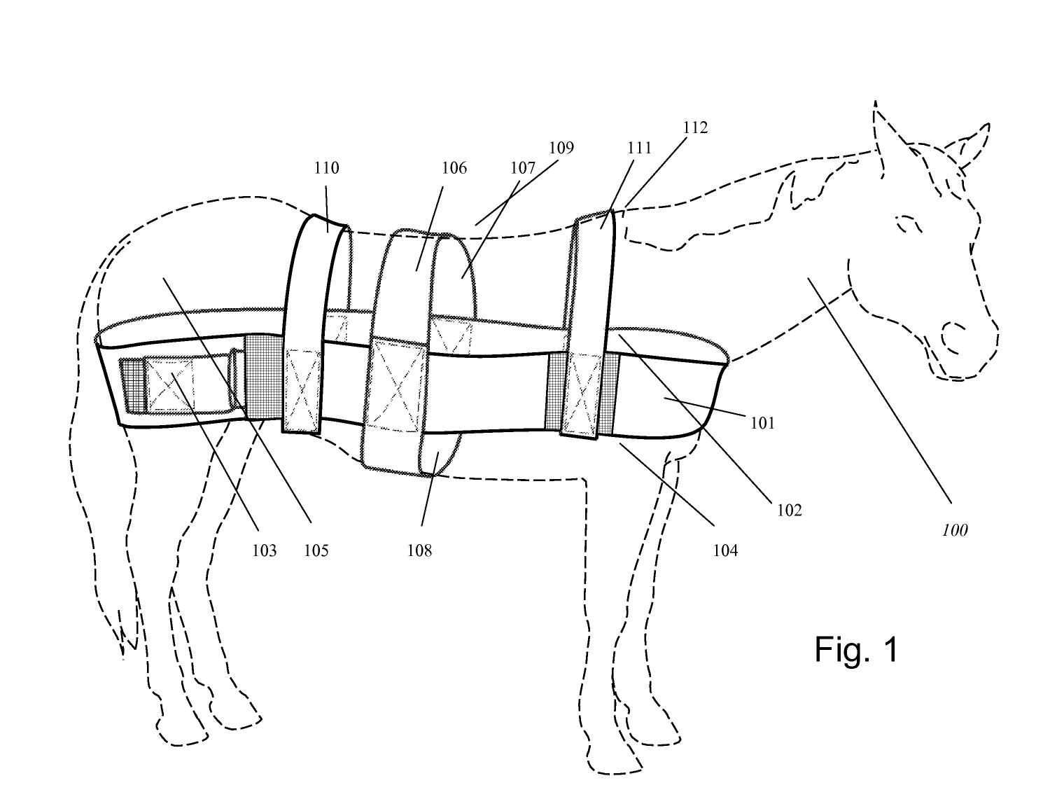

A preferred embodiment of the invention herein, the embodiment being specifically geared for an average sized riding horse ranging from 14.2 hands to 16.2 hands 100 with the elements being adjustable to achieve the same or similar effect for other sized animals, comprising a first elastic band 101 of a given length connected to create a completely enclosed circular shape, as provided in FIG. 1. The width of said first band 101 is approximately 10 inches wide in this specific embodiment. The circumference of said first band 101 being approximately the average circumferential length of the equine of a given age, type, and size 100. The first band 101 intended to be wrapped along the length of an equine 100 between a front end 102 immediately above the pectorals, below the neck, and encircling the mid body and encompassing the mid buttocks. The band has a minimal tension against the animal's body when worn. The amount of tension may vary depending on the therapy objective sought to be achieved and the animal characteristics that is involved. The preferred embodiment provides elongation of 110% of the original gauge length, +/−10%. The preferred embodiment herein provides for adjustability to the length of various embodiments of the device to allow adjustment to the tension accordingly. According to the embodiment of FIG. 1, lateral adjustments 103 are located at right 201 and left rear sides 202 of the device and animal but do not necessarily need to be located in these two areas to achieve the same affect. The circumference of said band may be adjusted by loosening and tightening portions 201, 202 along the strap 101 as provided in FIG. 1. Said adjustment portions 201, 202 may be held in place by any known connection method upon achieving the proper tension around the animal's body. The band may be comprised of any type of soft elastic material, preferably of a breathable fabric like texture and composition. Ideally, the material would have minimal resistance against the animal's body or hair so as to minimize negative rubbing affect over the worn area where direct contact is made. The material further having a preferred tensile strength for purposes of maintaining long term elastic strength from multiple reuse as well as to provide the desired level of resistance training. When in use, the first band 101 stretches between the animal's front portion 104 and hind portion 105 in a parallel horizontal manner relative to the animal's body. The elastic pressure against the animal's body along this horizontal length creates a heightened sense of awareness to the coordinating movement between these two more disparate sections of the body.

A second elastic band 203, 106 is located in the vertical position around the midsection 107 of the animal or horse. Specifically, this second band 203, 106 is intended to encourage proper posture in the equine animal. The second band 203, 106 also being no less than six inches wide and is approximately six inches wide in this specific embodiment. Said second band 203, 106 further having a circumferential length of approximately the average circumferential length around the midsection 107 of the horse between its lower stomach area 108 and its central upper arch 109, as demonstrated in FIG. 1. The second elastic band 201, 109 being connected to the first band 101 near the lower midsection area 108 of the animal's body. The first 101 and second band's 203 connection around the horse's body 100 encourages the animal to lift its belly resulting in a rounded and lengthened spine, improving posture and gait. Lengthening of the spine is the resulting of a decrease in compression of vertebrae and an increase in the space between the vertebrae. When the spine is in alignment, the neck lowers to a more neutral and balanced position.

An alternative embodiment having the same components as the preferred embodiment described above, further comprising a third 111 and fourth band 110 in contact with upper front 104 and upper rear side 105 of the horse, respectively, as provided in FIG. 1. The third band 111 being connected to the left and right sides of the first band 101 at the upper front end such that the third band 110 rests over the base of the animal's lower neck 112 region. The third band 111 having a connection point to the left and the right side of the front portion of the first band 101 as it is worn on the animal. See FIG. 1. The third band 111 being no less than four inches in width and having a preferred level of tensity, in this case elongation being 110% of original gauge length and +/−10%. A minimal amount of pressure is exerted against the horse's upper shoulder blades by the third band 111 when in use. A fourth band 110 is similarly connected to the upper portion of the first band 101 to the animal's rear 105. When in use, the fourth band 110 is positioned above the horse's upper hind quarter 105. The fourth band being no less than four inches in width with a preferred level of tensity. Both third 111 and fourth 110 bands may further be adjustable to vary the length or the degree of pressure against the animal's body. When in use, the constant light pressure of the third 111 and 110 fourth bands against the upper front and hind leg muscle groups creating a sense of stability and awareness in the horse during motion. The four interconnected bands 101, 106, 110, 111 creating a uniform and real time sense of awareness to muscle movements and posture, reinforcing security and confidence in the horse as it trains or rehabilitates its proprioception coordination.

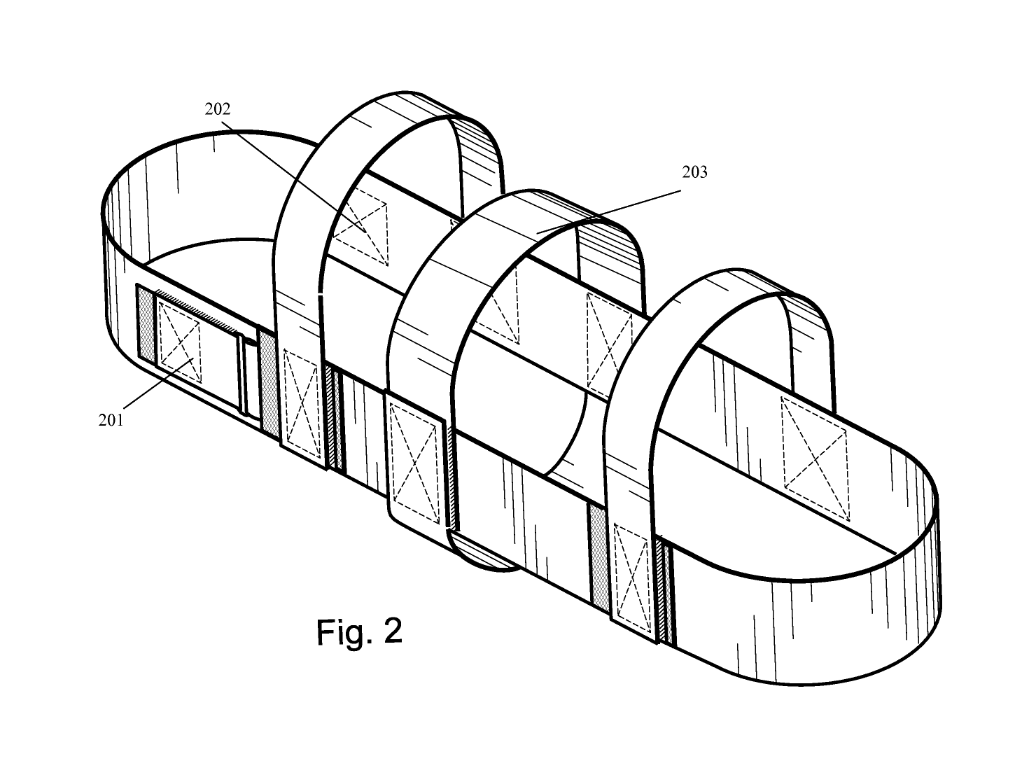

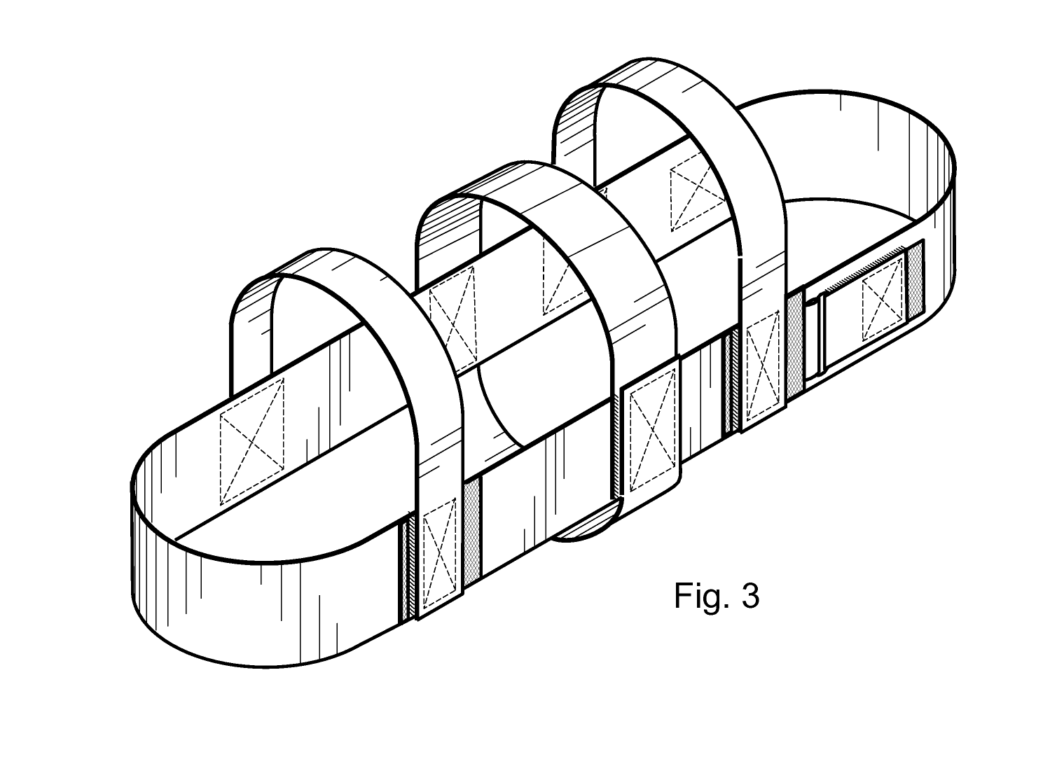

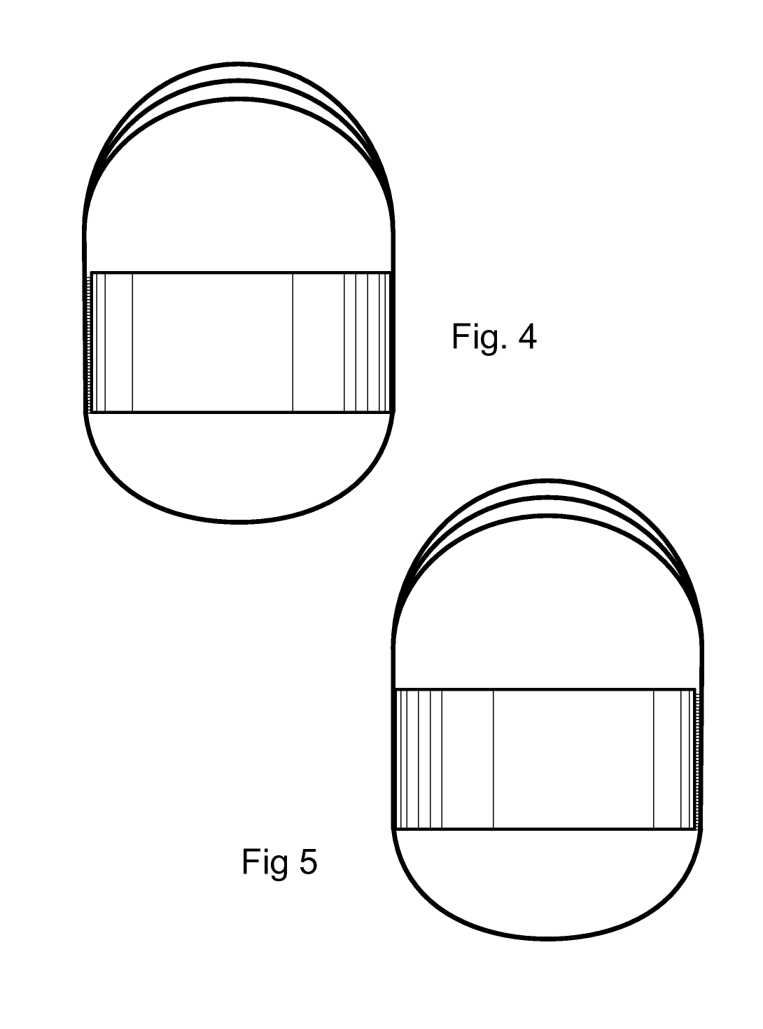

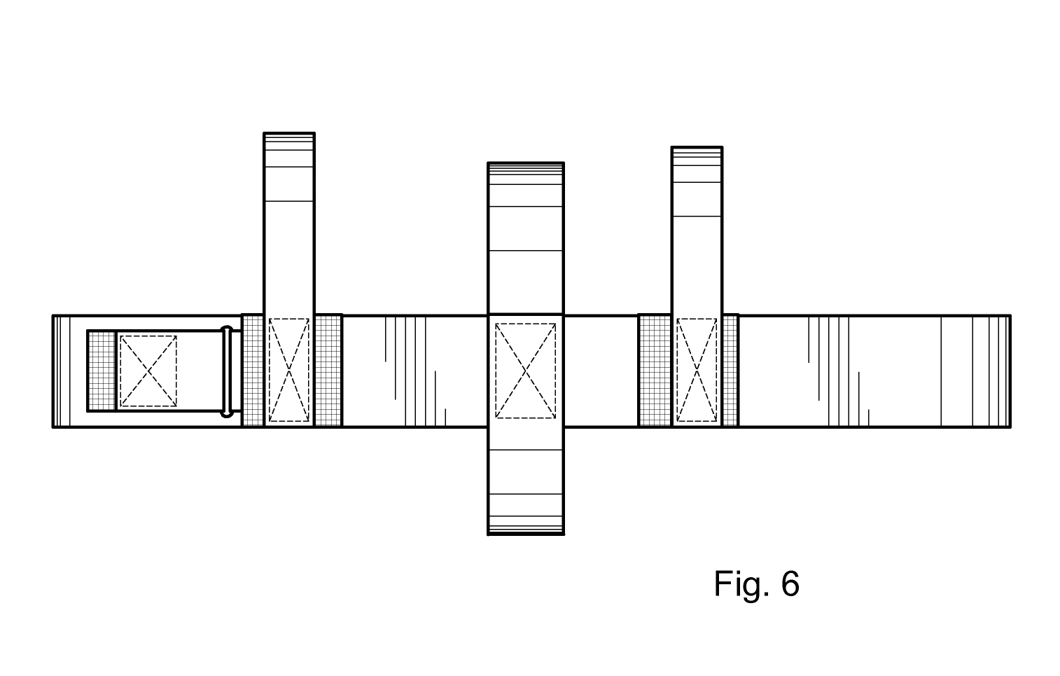

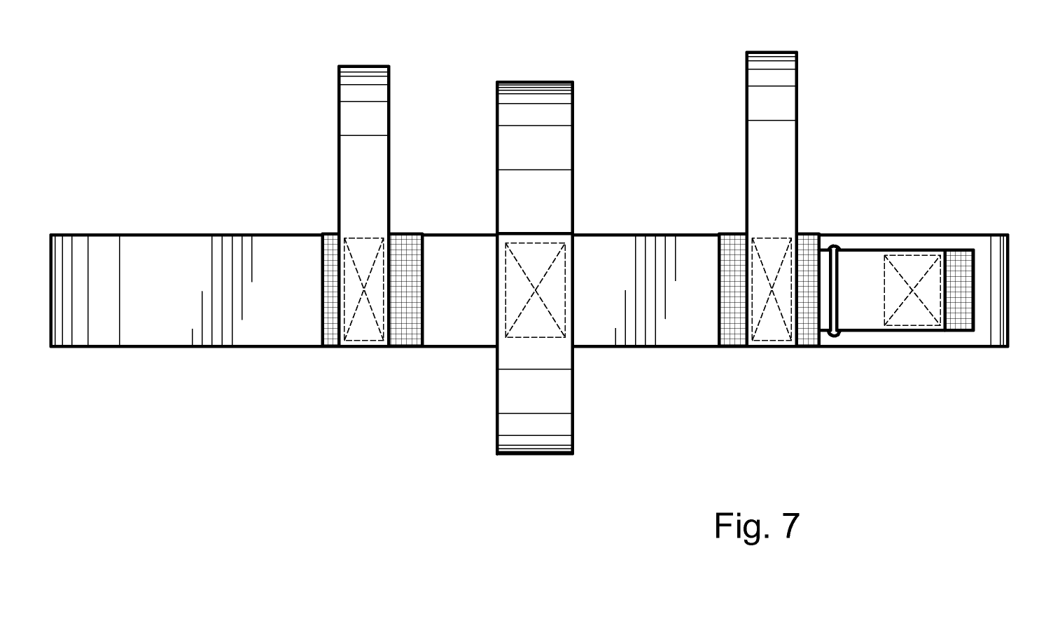

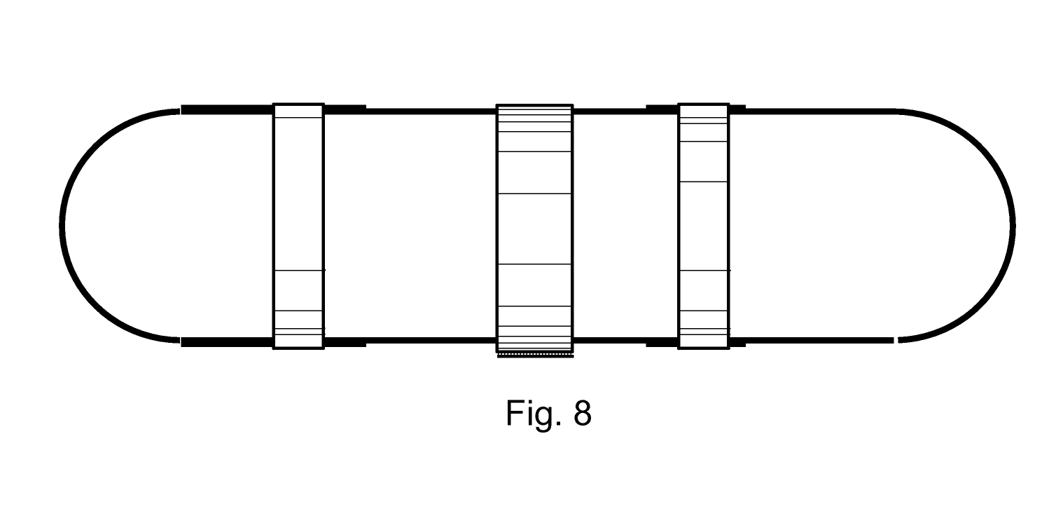

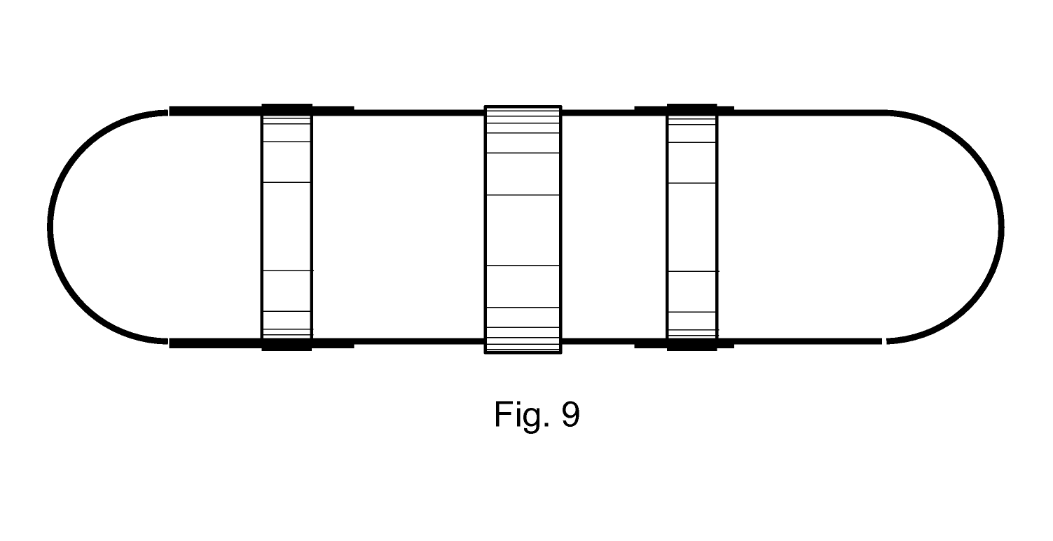

Connection and adjustment points may be located at either right or left sides of the device or alternatively on both sides. The preferred embodiment of FIGS. 2, 3 6, 7, 8 and 9 provides for lateral adjustments to the rear on both sides of the device and attachment points for the vertical bands on the right side of the device, as worn by the animal. FIGS. 4 and 5 provide a plan view of the device from rear and front sides, respectively. Alternative methods of design that accomplishes the claimed affect of this invention would be inherent to the invention herein.

The overall benefit and effect of this tool is multifaceted. Benefits include but are not limited to the following: 1) exercise with increased resistance (decreased number of repetitions required with increased intensity of work outs while increasing work of selected muscle groups with less strain), 2) improved forward propulsion while engaging hind quarters, 3) calming effect on the animal, 4) improves gait and comfort to the horse and rider, 5) serves as a diagnostic tool for assessing injury for imbalance. The animal wearing the device is in an improved and more balanced posture and compensation is disrupted, thereby revealing the area of weakness or injury.

Having fully described at least one embodiment of the present invention, other equivalent or alternative methods according to the present invention will be apparent to those skilled in the art. The invention has been described by way of summary, detailed description and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

I claim:

1. A rehabilitation and training device that is worn by quadruped animals comprising a first, second, third and fourth interconnected elastic bands, said first band comprising a circular length of elastic material in horizontal position having a width that is no greater than half the diameter of the user's cross-sectional mid-section, a second band comprising a circular length of elastic material positioned centrally around said first elastic band in vertical manner contacting and bisecting said first band at two opposing locations, a third band comprising a circular length of elastic material in contact with said first band at two opposing locations creating a bridge above said first band at a first front end, a fourth band comprising a circular length of elastic material in contact with said first band at two opposing locations creating a bridge above said first band at a first rear end.

2. A rehabilitation and training system for quadruped animals comprising:
a device having a first, second, third and fourth interconnected elastic bands, said first band comprising a circular length of elastic material in horizontal position having a width that is no greater than half the diameter of the user's cross-sectional mid-section, a second band comprising a circular length of elastic material positioned centrally around said first elastic band in vertical manner contacting and bisecting said first band at two opposing locations, a third band comprising a circular length of elastic material in contact with said first band at two opposing locations creating a bridge above said first band at a first front end, a fourth band comprising a circular length of elastic material in contact with said first band at two opposing locations creating a bridge above said first band at a first rear end,
said first band being worn horizontally around the body of said quadruped wrapping around its forequarter and hindquarter, said second band being wrapped around the quadruped midsection around its back arch and its lower stomach, said third band being wrapped above the quadruped front quarter above its shoulders and said fourth band being wrapped above the quadruped hind quarter,
said elastic material of said device having a elasticity or tensil strength sufficient to create a snug feel between the front, mid and rear muscle groups of said quadruped such that each muscle group is able to sense the interaction of the other muscle groups in contact with the elastic material.
